(19) United States
(12) Patent Application Publication
(10) Pub. No.: US 2022/0346421 A1
(43) Pub. Date: Nov. 3, 2022

(54) AGENT FOR FORMING CRISPY WINGS ON GYOZA DUMPLINGS

(71) Applicant: AJINOMOTO CO., INC., Tokyo (JP)

(72) Inventors: Shogo HIRAE, Kawasaki-shi (JP); Kohei KAWAMURA, Kawasaki-shi (JP); Kaori KAWAMURA, Kawasaki-shi (JP)

(73) Assignee: AJINOMOTO CO., INC., Tokyo (JP)

(21) Appl. No.: 17/860,332

(22) Filed: Jul. 8, 2022

Related U.S. Application Data
(63) Continuation of application No. PCT/JP2021/000426, filed on Jan. 8, 2021.

(30) Foreign Application Priority Data
Jan. 9, 2020 (JP) 2020-002177

(51) Int. Cl. A23L 29/212; A23L 7/10; A23L 7/13; A23L 5/00; A23L 29/10

(52) U.S. Cl. CPC A23L 29/212; A23L 7/198; A23L 7/13; A23L 5/00; A23L 29/10

(57) ABSTRACT

An agent for forming wings on gyoza dumplings that has a pH of not less than 8.3, can form large spreading wings, suppress frying unevenness in the wings and fried surfaces, and suppress unfried residues.

### CROSS REFERENCES TO RELATED APPLICATIONS

This application is a continuation of International Patent Application No. PCT/JP2021/000426, filed on Jan. 8, 2021, and claims priority to Japanese Patent Application No. 2020-002177, filed on Jan. 9, 2020, both of which are incorporated herein by reference in their entireties.

### BACKGROUND OF THE INVENTION

### Field of the Invention

The present invention relates to agents for forming wings on gyoza dumplings. Also, the present invention relates to frozen gyoza dumplings and production methods thereof. Furthermore, the present invention relates to production methods of a gyoza dumpling with wing and methods for improving the spread of the wing of a gyoza dumpling with wing.

### Discussion of the Background

Gyoza dumplings are one of the side dishes highly popular among the consumers. The cooking method thereof generally includes heating (steaming and frying, etc.) in a frying pan, a gyoza dumpling frying machine or the like to give a fried gyoza dumpling. Some fried gyoza dumpling has a “wing” (also called “BARI”, etc.) on the fried surface or its surrounding area (gyoza dumpling with wing). As a method for producing such gyoza dumpling with wing, it has been conventionally proposed to attach wing materials (e.g., batter liquid, etc.) to the bottom surface and the like of gyoza dumplings in advance and heat the gyoza dumplings to form wings on the fried gyoza dumplings.

For example, frozen gyoza dumplings produced by freezing an unheated agent for forming wings on gyoza dumplings containing water, grain flour, oil, and emulsifier, and heated gyoza dumplings in combination (see WO 2019/021348, which is incorporated herein by reference in its entirety) and the like have been reported.

### SUMMARY OF THE INVENTION

Gyoza dumplings with wings are required to have large wings that look good (large spreading wings), suppress the development of frying unevenness in the wings and fried surfaces, suppress the development of unfried residue of wing materials, and the like. The frozen gyoza dumpling described in WO 2019/021348 has problems that an unfried residue of the agent for forming wings on gyoza dumplings is developed after forming the wings by heating, and the like. Therefore, in gyoza dumplings with wings, it is extremely difficult to provide an agent for forming wings on gyoza dumplings, which can simultaneously achieve all of large spreading wings (having large wings), suppression of the development of frying unevenness in the wings and fried surfaces, and suppression of the development of unfried residues.

The present invention has been made in view of the aforementioned situation and the problem to be solved with respect to gyoza dumplings with wings is to provide an agent for forming wings on gyoza dumplings, which can form large spreading wings, suppress frying unevenness in the wings and fried surfaces, and suppress unfried residues.

These and other objects have been achieved by present inventors' discovery that, in winged gyoza dumplings obtained by adhering an agent for forming wings on gyoza dumplings, which is the material of the wing of gyoza dumpling, to the surface of gyoza dumplings and heating same, large spreading wings, suppression of frying unevenness in the wings and fried surfaces, and suppression of unfried residues of the agent for forming wings on gyoza dumplings can be achieved by adjusting the pH of the agent for forming wings on gyoza dumplings to a specific pH.

That is, the present invention provides the following.

(1) An agent for forming a wing on a gyoza dumpling, the agent having a pH of not less than 8.3.
(2) The agent of (1), wherein the pH is not less than 9.
(3) The agent of (1) or (2), wherein the pH is not more than 14.
(4) The agent of any one of (1) to (3), comprising water and at least one selected from starches and grain flour.
(5) The agent of (4), further comprising an oil and an emulsifier.
(6) The agent of any one of (1) to (5), wherein the agent is adhered to a surface of a gyoza dumpling in an amount of 2.5 to parts by weight per 100 parts by weight of the gyoza dumpling.
(7) A food set for production of a gyoza dumpling with a wing, comprising at least the agent of any one of (1) to (6) and a gyoza dumpling in combination.
(8) A frozen gyoza dumpling comprising an agent for forming wings on gyoza dumplings and having a pH of not less than 8.3 adhered in a frozen state.
(9) The frozen gyoza dumpling of (8), wherein the pH of the agent is not less than 9.
(10) The frozen gyoza dumpling of (8) or (9), wherein the pH of the agent is not more than 14.
(11) The frozen gyoza dumpling of any one of (8) to (10), wherein the agent comprises water and at least one selected from starches and grain flour.
(12) The frozen gyoza dumpling of (11), wherein the agent further comprises an oil and an emulsifier.
(13) The frozen gyoza dumpling of any one of (8) to (12), wherein the agent is adhered in an amount of 2.5 to 35 parts by weight per 100 parts by weight of the gyoza dumpling.
(14) A method for producing a frozen gyoza dumpling, comprising adhering, in a frozen state, an agent for forming a wing on a gyoza dumpling and having a pH of not less than 8.3.
(15) A method for producing a gyoza dumpling with a wing, comprising heating a frozen gyoza dumpling to which an agent for forming a wing on a gyoza dumpling and having a pH of not less than 8.3 is adhered in a frozen state.
(16) A method for producing a gyoza dumpling with a wing, comprising adhering an agent for forming a wing on a gyoza dumpling and having a pH of not less than 8.3 to a surface and heating the gyoza dumpling.
(17) The production method of any one of (14) to (16), wherein the agent has a pH of not less than 9.
(18) The production method of any one of (14) to (17), wherein the agent has a pH of not more than 14.
(19) The production method of any one of (14) to (18), wherein the agent comprises water and at least one selected from starches and grain flour.
(20) The production method of (19) wherein the agent further comprises an oil and an emulsifier.
(21) The production method of any one of (14) to (20), wherein the agent is adhered in an amount of 2.5 to 35 parts by weight per 100 parts by weight of the gyoza dumpling.
(22) A method for improving spread of a wing of a gyoza dumpling with a wing, comprising adjusting pH of an agent for forming a wing on a gyoza dumpling to not less than 8.3, and adhering the agent to a surface of the gyoza dumpling and heating the gyoza dumpling.
(23) The method of (22), wherein the agent has a pH of not less than 9.
(24) The method of (22) or (23), wherein the agent has a pH of not more than 14.
(25) The method of any one of (22) to (24), wherein the agent comprises water and at least one selected from starches and grain flour.
(26) The method of (25), wherein the agent further comprises an oil and an emulsifier.
(27) The method of any one of (22) to (26), wherein the agent is adhered in an amount of 2.5 to 35 parts by weight per 100 parts by weight of the gyoza dumpling.

### Advantageous Effects of Invention

According to the present invention, an agent for forming wings on gyoza dumplings, that can form large spreading wings, suppress frying unevenness in the wings and fried surfaces, and suppress unfried residues can be provided.

According to the present invention, moreover, a frozen gyoza dumpling that can make a winged gyoza dumpling having large spreading wing, in which frying unevenness in the wings and fried surfaces is suppressed, and unfried residue of an agent for forming wings on gyoza dumplings is suppressed, can be provided.

In addition, according to the present invention, a winged gyoza dumpling having large wings that look good, and can suppress frying unevenness in the wings and fried surfaces, and unfried residues of an agent for forming wings on gyoza dumplings, and a production method thereof can be provided.

### BRIEF DESCRIPTION OF THE DRAWINGS

FIG. 1 is a photograph of a typical example of gyoza dumplings with wings that can be evaluated as “◯” based on the evaluation criteria of the spread of wings in Experimental Examples 1 to 6. The photograph was taken from above of the winged gyoza dumplings on a cooking device.

FIG. 2 is a photograph of a typical example of gyoza dumplings with wings that can be evaluated as “Δ” based on the evaluation criteria of the spread of wings in Experimental Examples 1 to 6. The photograph was taken from above of the winged gyoza dumplings on a cooking device.

FIG. 3 is a photograph of a typical example of gyoza dumplings with wings that can be evaluated as “x” based on the evaluation criteria of the spread of wings in Experimental Examples 1 to 6. The photograph was taken from above of the winged gyoza dumplings on a cooking device.

FIG. 4 is a photograph of a typical example of gyoza dumplings with wings that can be evaluated as “◯” based on the evaluation criteria of the frying unevenness in the wings and fried surfaces in Experimental Examples 1 to 6. The photograph was taken of the bottom surface (fried surface, wings) of the winged gyoza dumplings that were transferred to a container.

FIG. 5 is a photograph of a typical example of gyoza dumplings with wings that can be evaluated as “Δ” based on the evaluation criteria of the frying unevenness in the wings and fried surfaces in Experimental Examples 1 to 6. The photograph was taken of the bottom surface (fried surface, wings) of the winged gyoza dumplings that were transferred to a container.

FIG. 6 is a photograph of a typical example of gyoza dumplings with wings that can be evaluated as “x” based on the evaluation criteria of the frying unevenness in the wings and fried surfaces in Experimental Examples 1 to 6. The photograph was taken of the bottom surface (fried surface, wings) of the winged gyoza dumplings that were transferred to a container.

FIG. 7 is a photograph of a typical example of gyoza dumplings with wings that can be evaluated as “◯” based on the evaluation criteria of the unfried residue of a batter liquid in Experimental Examples 1 to 6. The photograph was taken from above of the winged gyoza dumplings on a cooking device.

FIG. 8 is a photograph of a typical example of gyoza dumplings with wings that can be evaluated as “A” based on the evaluation criteria of the unfried residue of a batter liquid in Experimental Examples 1 to 6. The photograph was taken from above of the winged gyoza dumplings on a cooking device.

FIG. 9 is a photograph of a typical example of gyoza dumplings with wings that can be evaluated as “x” based on the evaluation criteria of the unfried residue of a batter liquid in Experimental Examples 1 to 6. The photograph was taken from above of the winged gyoza dumplings on a cooking device.

### DETAILED DESCRIPTION OF THE PREFERRED EMBODIMENTS

In the present invention, the composition for “agent for forming wings on gyoza dumplings” refers to a composition that can form a wing by being adhered to the surface of a gyoza dumpling and heated (e.g., steaming, frying, etc.), namely, a material of gyoza dumpling wings. The agent for forming wings on gyoza dumplings essentially contains water, and at least one selected from starches and grain flour. The agent for forming wings on gyoza dumplings may freely contain an oil, an emulsifier, a seasoning, or the like in addition to water, and at least one selected from starches and grain flour.

In the present invention, the “wing” of a gyoza dumpling refers to a thin film-like part with a crunchy texture, which is formed on the fried surface and its surrounding area of a gyoza dumpling, and is generally also called “BARI”. As used herein, the “fried surface” of a gyoza dumpling refers to a surface that is in contact with a cooking device used for heating (e.g., frying pan, gyoza dumpling frying machine, iron plate, hot plate, etc.), or a surface that is provided close to a cooking device and heated, so that a fried mark (burnt mark) will be imparted by the heating.

The “gyoza dumpling” in the present invention is not limited by its shape, production method and the like and can widely include those generally called gyoza dumpling. It typically refers to food products that have at least a filling (mixture of ground meat, vegetable, seasoning and the like) and an outer skin (dough made by adding water to flour, etc., kneading, and spreading thinly) that wraps the filling. The “gyoza dumpling” in the present specification is a concept widely encompassing food products having at least a filling and an outer skin wrapping the filling, and also encompassing, for example, xiaolongbao dumpling, shaomai dumpling, Chinese chive dumpling, etc. The “gyoza dumpling” in the present invention may be a filling wrapped with the outer skin and yet to be heated, or that after a heat treatment (e.g., heating by steaming, heating by frying, heating by boiling, etc.), and is a concept including both of these. In the present invention, a gyoza dumpling with a filling wrapped with the outer skin and yet to be heated is sometimes referred to as a “raw gyoza dumpling” for convenience, and a gyoza dumpling after a heat treatment (heat cooking) and in a state suitable for eating is sometimes referred to as a “heated gyoza dumpling” for convenience. The “gyoza dumpling” in the present invention also includes a gyoza dumpling in a chilled state (chilled gyoza dumpling). The weight of one gyoza dumpling is not particularly limited and is generally about 10 to 45 g.

One of the characteristics of the agent of the present invention for forming wings on gyoza dumplings (simply referred to as “the agent of the present invention” at times in the present specification) is that it has a specific pH. The agent of the present invention having such specific pH attaches to the surface of a gyoza dumpling, a heated gyoza dumpling after wing formation (gyoza dumpling with wing) obtained by heating the gyoza dumpling using a cooking device (e.g., frying pan, gyoza dumpling frying machine, iron plate, hot plate, etc.) has large spreading wings, and the agent for forming wings on gyoza dumplings suppresses frying unevenness in wings and fried surfaces, and suppresses unfried residue of the agent.

Specifically, the pH of the agent of the present invention at 25° C. is preferably not less than 8.3, more preferably not less than 8.5. It is particularly preferably not less than 9 because frying unevenness in wings and fried surfaces of a gyoza dumpling after wing formation (gyoza dumpling with wing), and an unfried residue of the agent for forming wings on gyoza dumplings can be more effectively suppressed. The pH of the agent of the present invention at 25° C. is preferably not more than 14, more preferably not more than 13.5.

The measurement method of the pH of the agent of the present invention is not particularly limited, and the pH may be measured by a method known per se or a method analogous thereto. For example, the pH of the agent of the present invention can be measured using a pH meter or the like such as “TPX-999” manufactured by toko chemical laboratories co. ltd., and the like.

The method for adjusting the pH of the agent of the present invention is not particularly limited, and it can be adjusted by a method known per se or a method analogous thereto. For example, it can be adjusted to a given pH by appropriately using water (e.g., alkaline electrolyzed water, etc.) adjusted to alkaline as a part of or the whole water used for preparing the agent of the present invention. As used herein, the “alkaline electrolyzed water” is an alkaline aqueous solution obtained on the cathode side when a small amount of an electrolyte (e.g., sodium chloride, etc.) is added to water for electrolysis. In addition, the agent of the present invention can also be adjusted to a predetermined pH by adding an alkali agent to the agent of the present invention. Therefore, the agent of the present invention may contain an alkali agent.

The alkali agent that can be used to adjust the pH of the agent of the present invention is not particularly limited as long as it can be used for food products. Examples thereof include carbonate (e.g., sodium carbonate, sodium hydrogen carbonate, potassium carbonate, etc.), phosphate (e.g., disodium hydrogen phosphate, sodium dihydrogen phosphate, trisodium phosphate, etc.), condensed phosphate (e.g., polyphosphate, metaphosphate, etc.), pyrophosphate (e.g., disodium dihydrogen pyrophosphate, tetrasodium pyrophosphate, tetrapotassium pyrophosphate, etc.), hydroxide salt (e.g., potassium hydroxide, sodium hydroxide, calcium hydroxide, etc.), calcinated calcium, basic amino acid (e.g., lysine, arginine, histidine, etc.), and the like. These alkali agents may be used alone or two or more kinds thereof may be used in combination.

When the pH of the agent of the present invention is adjusted by adding an alkali agent (that is, when the agent of the present invention contains an alkali agent), the content of the alkali agent in the agent of the present invention is not particularly limited as long as the agent of the present invention has a specific pH. It is generally not more than 5 wt %, preferably not more than 3 wt %, based on the agent of the present invention.

The agent of the present invention generally contains water and at least one selected from starches and grain flour. The agent of the present invention may further contain an oil, in addition to water, and at least one selected from starches and grain flour.

Examples of the water contained in the agent of the present invention include, but are not limited to, distilled water, purified water such as ion-exchanged water, etc., tap water, alkaline electrolyzed water, and the like, and one suitable as water for food production can be used.

The content of water in the agent of the present invention is preferably not less than 20 wt %, more preferably not less than 30 wt %, particularly preferably not less than 40 wt %, with respect to the agent of the present invention. In one embodiment, the content is preferably not less than 50 wt %, more preferably not less than 55 wt %, particularly preferably not less than 60 wt %, with respect to the agent of the present invention. The content is preferably not more than 85 wt %, more preferably not more than 80 wt %, particularly preferably not more than 75 wt %, with respect to the agent of the present invention.

The agent of the present invention contains at least one selected from starches and grain flour. As used herein, the “grain flour” refers to a powdery or granular food raw material obtained by milling or pulverizing grains.

The starches that can be contained in the agent of the present invention are not particularly limited and, for example, starches such as non-glutinous rice starch, glutinous rice starch, wheat starch, corn starch, waxy corn starch, tapioca starch, sago palm starch, mung bean starch, potato starch, sweet potato starch, and the like can be mentioned. It is preferably non-glutinous rice starch or glutinous rice starch. As the starch, modified starches of these starches may also be used. As used herein, the “modified starch” refers to starch subjected to at least one processing treatment selected from the group consisting of a physical treatment, a chemical treatment, and an enzymatical treatment. Examples of the starch subjected to a chemical treatment include acetylated distarch adipate, acetylated distarch phosphate, acetylated oxidized starch, starch sodium octenylsuccinate, starch acetate, oxidized starch, hydroxypropyl starch, hydroxypropyl distarch phosphate, phosphated distarch phosphate, monostarch phosphate, distarch phosphate and the like. Examples of the starch subjected to a physical treatment (including simple chemical treatments of the level of hydrolysis such as acid treatment, alkaline treatment, bleaching treatment and the like) include pregelatinized starch, heat-moisture treated starch, oil coated starch, acid-treated starch, alkaline treated starch, bleached starch and the like. Examples of the starch subjected to an enzymatical treatment include enzyme-treated starch and the like. The kind of the modified starch to be used in the present invention is not particularly limited as long as it is edible, and a starch subjected to at least a chemical treatment and a starch subjected to at least a physical treatment are preferred, and starch acetate, distarch phosphate, and acid-treated starch are particularly preferred. These modified starches may be subjected to one processing treatment selected from the group consisting of a physical treatment, a chemical treatment and an enzymatical treatment, or may be subjected to not less than two processing treatments selected from the group consisting of a physical treatment, a chemical treatment and an enzymatical treatment.

While the grain flour that the agent of the present invention may contain is not particularly limited, wheat flour, rice flour, corn flour, barley flour, buckwheat flour, potato flour, soybean flour, adzuki bean flour, barnyard millet flour, chestnut flour, millet flour, and the like can be mentioned. Among these, rice flour is preferred since it has a low protein content and can easily confer a crispy texture to a fried surface after heating.

The production method of starches and grain flour that the agent of the present invention may contain is not particularly limited, and those produced by a method known per se or a method analogous thereto may be used. For example, grain flour can be produced by milling or pulverizing grains into powder or granule, and the like. As the starches and grain flour, commercially available products may be used, and such use is convenient and preferable.

The content of at least one selected from starches and grain flour in the agent of the present invention is preferably not less than 0.1 wt %, more preferably not less than 0.5 wt %, further preferably not less than 1 wt %, particularly preferably not less than 3 wt %, with respect to the agent of the present invention. In addition, the content is preferably not more than 15 wt %, more preferably not more than 10 wt %, particularly preferably not more than 8 wt %, with respect to the agent of the present invention. As used herein, the “content of at least one selected from starches and grain flour” in the agent of the present invention means the content of only one of starches and grain flour when the agent of the present invention contains only one of starches and grain flour, and means the total content of the starches and grain flour when the agent of the present invention contains both starches and grain flour.

The oil contained in the agent of the present invention is not particularly limited as long as it is edible. An oil that lacks flowability at ordinary temperature is sometimes referred generally to as “fat”. The oil in the present invention is a concept also including fat. Specific examples of the oil that can be contained in the agent of the present invention include vegetable oils such as canola oil, soybean oil, safflower oil (including high linoleic safflower oil), corn oil, rape seed oil, sesame oil, flaxseed oil, sunflower oil, peanuts oil, cottonseed oil, olive oil, rice oil, palm oil, rice-bran oil, perilla oil, grapeseed oil and the like; animal oils such as lard, beef tallow, chicken oil, mutton tallow, horse tallow, fish oil, whale oil, butter and the like. In addition, transesterified oil obtained by transesterifying these oils, hydrogenated oil obtained by hydrogenating these oils, and the like can also be used. The oil that can be contained in the agent of the present invention may be a refined oil (e.g., salad oil, etc.). The oil that can be contained in the agent of the present invention is preferably vegetable oil, more preferably canola oil, soybean oil or rape seed oil. Only one kind of these oils may be used, or two or more kinds thereof may be used in combination.

The production method of the oil that may be contained in the agent of the present invention is not particularly limited, and an oil produced by a method known per se or a method analogous thereto may be used. As the oil, a commercially available product may be used, and such use is convenient and preferable.

When the agent of the present invention contains oil, the content of the oil in the agent of the present invention is preferably not less than 10 wt %, more preferably not less than 15 wt %, particularly preferably not less than 20 wt %, with respect to the agent of the present invention. The content is preferably not more than 40 wt %, more preferably not more than 35 wt %, particularly preferably not more than 30 wt %, with respect to the agent of the present invention.

The agent of the present invention may contain an emulsifier. The emulsifier that can be used in the present invention is not particularly limited as long as it is edible. For example, lecithin, enzyme-degraded lecithin, sugar ester, mono glycerol, propylene glycol fatty acid ester, polyglycerol fatty acid ester and the like can be recited. Only one kind of these emulsifiers may be used, or two or more kinds thereof may be used in combination.

The production method of the emulsifier that may be contained in the agent of the present invention is not particularly limited, and an emulsifier produced by a method known per se or a method analogous thereto may be used. As the emulsifier, a commercially available product may be used, and such use is convenient and preferable.

When the agent of the present invention contains an emulsifier, the content of the emulsifier in the agent of the present invention is not particularly limited as long as an emulsifying action is achieved, and is preferably not less than 0.05 wt %, more preferably not less than 0.1 wt %, particularly preferably not less than 0.2 wt %, with respect to the agent of the present invention. The content is preferably not more than 1.5 wt %, more preferably not more than 1 wt %, particularly preferably not more than 0.8 wt %, with respect to the agent of the present invention.

The agent of the present invention preferably further contains an oil in addition to water, and at least one selected from starches and grain flour. In this case, when the contents of “water”, “at least one selected from starches and grain flour” and “oil” in the agent of the present invention are a, b, and c parts by weight, respectively, and the total of a, b and c (=a+b+c) is 100 parts by weight, the ratio of a, b, c (a:b:c) is preferably a (water):b (at least one selected from starches and grain flour):c (oil)=50 to 85:0.1 to 15:10 to 40, more preferably 50 to 85:0.5 to 15:10 to 40, still more preferably a:b:c=55 to 80:1 to 10:15 to 35, further preferably a:b:c=60 to 75:1 to 10:20 to 35, and particularly preferably a:b:c=60 to 75:3 to 8:20 to 35.

The agent of the present invention may optionally contain, in addition to the above-mentioned components, components generally contained in the batter liquid of gyoza dumpling (e.g., seasonings, salts, saccharides, amino acids, proteins, gums, celluloses, emulsification adjuvants, etc.) as long as the purpose of the present invention is not impaired.

The preparation method of the agent of the present invention is not particularly limited, and it can be prepared by a method known per se or a method analogous thereto. For example, when the agent of the present invention contains water, starches or grain flour, and oil, the agent can be prepared by stirring these by a commercially available mixing and stirring device or the like, adjusting the mixture to a given pH, and the like.

The form of the agent of the present invention is preferably non-solid at ordinary temperature (25° C.). In the present invention, being “non-solid” at ordinary temperature (25° C.) means being flowable at ordinary temperature (25° C.), and examples of the form include liquid, slurry, paste and the like.

When the agent of the present invention is heated to 90° C., maintained for 10 min, and cooled to 50° C., the viscosity measured using a B-type viscometer is generally 0.1 to 5000 mPa·S.

As the B-type viscometer used for the measurement of the viscosity of the agent of the present invention, digital viscometer “LVDV-1+” manufactured by BROOKFIELD and the like can be mentioned.

The agent of the present invention may be or may not be emulsified at an ordinary temperature (25° C.). From the aspect of industrial productivity, the agent of the present invention may be an emulsion at an ordinary temperature (25° C.). The method for emulsifying the agent of the present invention is not particularly limited, and can be performed using a commercially available mixing and stirring device or the like and according to a method known per se or a method analogous thereto.

The agent of the present invention may be heated in advance, apart from the heating that makes a gyoza dumpling in a state suitable for eating, or may be substantially unheated. When the agent of the present invention is heated in advance, apart from the heating that makes a gyoza dumpling in a state suitable for eating, as the heating method, for example, heating by steaming and the like can be mentioned. Also, the heating conditions (e.g., heating temperature, heating time etc.) are not particularly limited and can be appropriately set according to the heating method and the like. The heating temperature is generally 70 to 120° C., preferably 90 to 100° C., and the heating time is generally 1 to 30 min, preferably 5 to 10 min. The agent of the present invention can be used while being adhered to the surface of a gyoza dumpling, heated together with the gyoza dumpling when it is heated to a state suitable for eating as mentioned below, and form wings on the fried surface and its surrounding area of the gyoza dumpling after heating. Therefore, when the agent of the present invention is heated in advance, the heating conditions (e.g., heating temperature, heating time, and the like) are preferably adjusted such that the moisture of the agent of the present invention is not excessively evaporated to cause solidification and the like.

In the present invention, that the agent of the present invention is “substantially unheated” means that the agent of the present invention is not heated at all, or lightly heat treated such that the components (e.g., grain flour, etc.) contained in the agent of the present invention are not denatured by heat.

The agent of the present invention may be provided as a batter liquid.

The agent of the present invention may be used while being adhered to the surface of a gyoza dumpling. The method for adhering the agent of the present invention to the surface of a gyoza dumpling and the embodiment of attachment are not particularly limited as long as a wing is formed on a gyoza dumpling heated to a state suitable for eating. It is preferable to attach the agent at least to a surface to be the fried surface of a gyoza dumpling. The agent of the present invention may be adhered to the entire surface to be the fried surface, or may be adhered to a part of the surface to be the fried surface, in the gyoza dumpling. The agent of the present invention may be adhered not only to the surface to be the fried surface of the gyoza dumpling but also to a surface continuous with the surface to be the fried surface (e.g., a side surface extending from the bottom surface, etc.).

The gyoza dumpling to which the agent of the present invention may be adhered is not particularly limited and the shape, size of the gyoza dumpling, components, constitution, amount of the filling and the outer skin (dough sheet), and the like may be appropriately determined according to the desired gyoza dumpling. The production methods of the filling and the outer skin, how to wrap the filling and the like can be performed according to a method known per se or a method analogous thereto. As the filling and the outer skin, commercially available products may be used, or commercially available gyoza dumplings may also be used.

In one embodiment, the gyoza dumpling to which the agent of the present invention can be adhered may be a raw gyoza dumpling or in another embodiment, a raw gyoza dumpling may be heated to a state not suitable for eating.

The gyoza dumpling to which the agent of the present invention may be adhered may be subjected to a treatment conventionally used for gyoza dumplings (e.g., treatment to deactivate enzymes contained in vegetables and the like in the filling, and the like) as appropriate.

The amount of the agent of the present invention adhered to a gyoza dumpling is not particularly limited and may be adjusted according to the size and shape of the desired wing. It is generally 2.5 to 35 parts by weight, preferably 4 to 32 parts by weight, more preferably 8 to 31 parts by weight, per 100 parts by weight of the gyoza dumpling.

A gyoza dumpling with the agent of the present invention adhered to its surface may be heated (e.g., steamed, fried, etc.) as it is using a cooking device until it reaches a state suitable for eating. By heating a gyoza dumpling with the agent of the present invention adhered to its surface until it reaches a state suitable for eating, wings are formed on the fried surface, its surrounding area, and the like of the gyoza dumpling, and a heated gyoza dumpling with wing (also to be referred to as gyoza dumpling with wing in the present specification) can be obtained.

According to the present invention, therefore, a method for producing a gyoza dumpling with wing, including adhering the agent of the present invention to its surface and heating the gyoza dumpling is also provided.

The heating conditions (e.g., heating temperature, heating time, etc.) of the gyoza dumpling with the agent of the present invention adhered to its surface are not particularly limited, and can be appropriately set according to the heating method and the like. The heating temperature is generally 80 to 300° C., preferably 90 to 250° C., more preferably 90 to 120° C., and the heating time is generally 3 to 30 min, preferably 5 to 15 min.

The agent of the present invention can be adhered in a frozen state to a frozen gyoza dumpling. According to the present invention, therefore, a gyoza dumpling with the agent of the present invention adhered in a frozen state to its surface is also provided.

In the present invention, the “frozen gyoza dumpling” is a concept encompassing a gyoza dumpling in a frozen state (frozen object itself obtained by freezing a raw gyoza dumpling or a heated gyoza dumpling), and a frozen food product containing a gyoza dumpling in a frozen state and food product ingredients in a frozen state (e.g., frozen food product containing gyoza dumpling in a frozen state and food product ingredients adhered in a frozen state to the gyoza dumpling, etc.). Therefore, a gyoza dumpling to which the agent of the present invention is adhered in a frozen state is also a frozen food product containing a gyoza dumpling in a frozen state, and the agent of the present invention adhered in a frozen state to the gyoza dumpling.

The method for adhering in a frozen state the agent of the present invention to a frozen gyoza dumpling is not particularly limited. The agent of the present invention can be adhered in a frozen state to a frozen gyoza dumpling by, for example, subjecting a gyoza dumpling with the agent of the present invention adhered to its surface to a freezing treatment before subjecting same to a heat treatment to achieve a state suitable for eating, and the like. Alternatively, the agent of the present invention can also be adhered in a frozen state to a frozen gyoza dumpling by freezing the agent of the present invention without adhesion to a gyoza dumpling, and adhering the obtained agent of the present invention in a frozen state to a gyoza dumpling in a frozen state, and the like.

A frozen gyoza dumpling to which the agent of the present invention is adhered in a frozen state may be directly subjected without thawing to heating (e.g., steaming, frying, etc.) using a cooking device to a state suitable for eating. A wing is also formed on the fried surface, its surrounding area, and the like of a gyoza dumpling by heating a frozen gyoza dumpling, to which the agent of the present invention is adhered in a frozen state, to a state suitable for eating, and a gyoza dumpling with wing can be obtained.

Therefore, the present invention also provides a production method of a gyoza dumpling with wing, including heating a frozen gyoza dumpling to which the agent of the present invention is adhered in a frozen state.

The heating conditions (e.g., heating temperature, heating time, etc.) of a frozen gyoza dumpling to which the agent of the present invention is adhered in a frozen state are not particularly limited, and can be appropriately set according to the heating method and the like. The heating temperature is generally 80 to 300° C., preferably 90 to 250° C., and the heating time is generally 3 to 30 min, preferably 5 to 15 min.

A gyoza dumpling with the agent of the present invention adhered to its surface and a frozen gyoza dumpling to which the agent of the present invention is adhered in a frozen state are heated (e.g., steamed, fried, etc.) using a cooking device (e.g., frying pan, gyoza dumpling frying machine, iron plate, hot plate, etc.) to a state suitable for eating. The resulting gyoza dumpling after wing formation (gyoza dumpling with wing) has large spreading wing, and frying unevenness in the wing and fried surface is suppressed, and an unfried residue of the agent for forming wings on gyoza dumplings is suppressed.

In the present invention, the degree of “spreading” of the wing of the gyoza dumpling with wing can be evaluated, for example, by sensory evaluation based on visual observation by an expert panel, and the like.

In the present invention, the “frying unevenness” of the wing and the fried surface of a gyoza dumpling with wing means that unfried areas (white spots), burnt black areas, etc. are unevenly formed on the wing and fried surface, and the degree thereof can be evaluated, for example, by sensory evaluation based on visual observation by an expert panel, and the like.

In the present invention, the “unfried residue” of an agent for forming wings on gyoza dumplings in gyoza dumplings with wings means that the agent for forming wings on gyoza dumplings remains on the surface of the gyoza dumpling without forming a wing even after heating to a state suitable for eating, and the degree thereof can be evaluated, for example, by sensory evaluation based on visual observation by an expert panel, and the like.

A winged gyoza dumpling which is obtained by heating a gyoza dumpling with the agent of the present invention adhered to its surface or a frozen gyoza dumpling to which the agent of the present invention is adhered in a frozen state, by using a cooking device to a state suitable for eating, may be subjected to a freezing treatment and provided in a frozen state. When a gyoza dumpling with wing is subjected to a freezing treatment, the freezing treatment is not particularly limited and may be performed according to a method known per se or a method analogous thereto. The freezing temperature is generally not more than −10° C., preferably not more than −15° C.

In the present invention, the gyoza dumplings (including frozen gyoza dumplings) may be provided in a container (e.g., tray, etc.). The container for housing gyoza dumplings is not particularly limited, and a conventional container may be used. For example, the containers and trays described in WO 2014/007387, WO 2016/19882, which are incorporated herein by reference in their entireties, or the like may be used. The gyoza dumplings may be provided in an outer packaging bag or the like instead of a container.

The embodiment in which the agent of the present invention is provided (sold, transferred, etc.) is not particularly limited. For example, the agent of the present invention may be provided separately from gyoza dumplings, or the agent of the present invention may be provided as a food set containing gyoza dumplings in combination. As described above, the agent of the present invention only needs to be adhered to the gyoza dumplings when the gyoza dumplings are heated to a state suitable for eating by using a cooking device, and the agent of the present invention may be provided even if it is not adhered to the gyoza dumplings. Therefore, the present invention also provides a food set in which at least the agent of the present invention and gyoza dumplings are combined (simply referred to as “food set of the present invention” at times in the present specification).

The form of the food set of the present invention is not particularly limited and, for example, a form in which the agent of the present invention and gyoza dumplings are housed in separate containers or packaging bags, and they are combined, and the like can be mentioned. The food set of the present invention may be a combination of the agent of the present invention, gyoza dumplings, and other food materials.

A gyoza dumpling with wing can be produced by subjecting the food set of the present invention to heat cooking (e.g., steaming, frying etc.). Therefore, the food set of the present invention is preferably used for producing gyoza dumplings with wings.

Using the agent of the present invention, gyoza dumplings with wings having large spreading wings (having large wings) can be obtained as described above. Therefore, the present invention also provides a method for improving spread of the wing of gyoza dumplings with wings (simply referred to as “the improvement method of the present invention” at times in the present specification).

The improvement method of the present invention is not particularly limited except that the pH of the agent for forming wings on gyoza dumplings (composition that can form wings when adhered to a surface of a gyoza dumpling and heated) is adjusted to a specific pH, and the agent for forming wings on gyoza dumplings is adhered to a surface of a gyoza dumpling and heated. In the improvement method of the present invention, the pH of the agent for forming wings on gyoza dumplings can be adjusted in the same manner as the pH of the agent of the present invention, and the preferred range and the adjustment method are also the same. In the improvement method of the present invention, the agent for forming wings on gyoza dumplings can be produced in the same manner as the agent of the present invention, and a preferred embodiment is also the same. In the improvement method of the present invention, the gyoza dumpling to which the agent for forming wings on gyoza dumplings is adhered is the same as a gyoza dumpling to which the agent of the present invention can be adhered, and a preferred embodiment is also the same. In addition, in the improvement method of the present invention, a method for adhering the agent for forming wings on gyoza dumplings to a surface of a gyoza dumpling, and a method for heating the gyoza dumpling with the agent for forming wings on gyoza dumplings adhered to its surface to a state suitable for eating can be respectively performed in the same manner as in the method for adhering the agent of the present invention to a surface of a gyoza dumpling, and a method for heating a gyoza dumpling with the agent of the present invention adhered to its surface until it reaches a state suitable for eating.

Other features of the invention will become apparent in the course of the following descriptions of exemplary embodiments which are given for illustration of the invention and are not intended to be limiting thereof.

### EXAMPLES

Unless particularly indicated, all the raw materials used in the following Examples are commercially available for food products.

### Making Raw Gyoza Dumpling

The raw gyoza dumplings used in the following Experimental Examples 1 to 6 were all made as described below.

Ground meat (mixture of ground pork meat and ground chicken meat, 260 g), vegetable (mixture of chopped cabbage, onion, Chinese chive, garlic, 550 g), egg white (25 g), sesame oil (20 g), sake (10 g), spice and seasoning (32 g, total amount of spice and seasoning) were mixed to prepare the filling. The obtained filling (12 g) was wrapped with commercially available gyoza dumpling skin (1 sheet: 5 g) to make raw gyoza dumplings (weight of one raw gyoza dumpling: 17 g).

### Experimental Example 1

### Preparation of Batter Liquid of Comparative Example 1

Of the raw materials shown in Table 1 below, city water (pH=7.1), glutinous rice starch (manufactured by Joetsu Starch Co., Ltd., “Motyl B”), egg white powder, and casein sodium (sold by Nippon Shinyaku Co., Ltd., “casein sodium S”) were mixed in the blending ratio shown in the following Table 1, and stirred using a commercially available homogenizer (manufactured by IKA JAPAN K.K., “T50 digital ULTRA-TURRAX (registered trade mark)”) (stirring conditions: 3000 rpm, 3 min). Then, salad oil, lecithin, and xanthan gum (manufactured by DSP GOKYO FOOD & CHEMICAL Co., Ltd., “ECHO GUM”) were added in the blending ratio shown in the following Table 1, and the mixture was emulsified by stirring again using the aforementioned homogenizer (stirring conditions: 3000 rpm, 9 min) to prepare the batter liquid of Comparative Example 1.

TABLE 1

| | |
|---|---|
| city water | 70.0 |
| glutinous rice starch | 5.0 |
| egg white powder | 0.2 |
| casein sodium | 0.6 |
| salad oil | 23.6 |
| lecithin | 0.4 |
| xanthan gum | 0.2 |
| total (wt %) | 100.0 |

### Preparation of Batter Liquid of Comparative Example 2

The batter liquid of Comparative Example 2 was prepared in the same manner as the batter liquid of Comparative Example 1 except that a mixed solution of city water (pH=7.1) and alkaline electrolyzed water (pH=13.8) at a ratio (weight ratio) of city water:alkaline electrolyzed water=99.97:0.03 was used in place of city water.

### Preparation of Batter Liquid of Comparative Example 3

The batter liquid of Comparative Example 3 was prepared in the same manner as the batter liquid of Comparative Example 1 except that a mixed solution of city water (pH=7.1) and alkaline electrolyzed water (pH=13.8) at a ratio (weight ratio) of city water:alkaline electrolyzed water=99.8:0.2 was used in place of city water.

### Preparation of Batter Liquid of Example 1

The batter liquid of Example 1 was prepared in the same manner as the batter liquid of Comparative Example 1 except that a mixed solution of city water (pH=7.1) and alkaline electrolyzed water (pH=13.8) at a ratio (weight ratio) of city water:alkaline electrolyzed water=99:1 was used in place of city water.

### Preparation of Batter Liquid of Example 2

The batter liquid of Example 2 was prepared in the same manner as the batter liquid of Comparative Example 1 except that a mixed solution of city water (pH=7.1) and alkaline electrolyzed water (pH=13.8) at a ratio (weight ratio) of city water:alkaline electrolyzed water=98:2 was used in place of city water.

### Preparation of Batter Liquid of Example 3

The batter liquid of Example 3 was prepared in the same manner as the batter liquid of Comparative Example 1 except that a mixed solution of city water (pH=7.1) and alkaline electrolyzed water (pH=13.8) at a ratio (weight ratio) of city water:alkaline electrolyzed water=95:5 was used in place of city water.

### Preparation of Batter Liquid of Example 4

The batter liquid of Example 4 was prepared in the same manner as the batter liquid of Comparative Example 1 except that a mixed solution of city water (pH=7.1) and alkaline electrolyzed water (pH=13.8) at a ratio (weight ratio) of city water:alkaline electrolyzed water=90:10 was used in place of city water.

### Preparation of Batter Liquid of Example 5

The batter liquid of Example 5 was prepared in the same manner as the batter liquid of Comparative Example 1 except that alkaline electrolyzed water (pH=13.8) was used in place of city water.

### Measurement of pH of Batter Liquid

The pH of the batter liquids of Examples 1 to 5 and Comparative Examples 1 to 3 at 25° C. was each measured using a pH meter (manufactured by toko chemical laboratories co. ltd., “TPX-999”). The results are shown in the following Table 2.

### Making Frozen Gyoza Dumplings of Examples 1 to 5 and Comparative Examples 1 to 3

Using the batter liquids of Examples 1 to 5 and Comparative Examples 1 to 3, frozen gyoza dumplings with each batter liquid adhered in a frozen state to the surface to be fried surface were made (frozen gyoza dumplings of Examples 1 to 5 and Comparative Examples 1 to 3).

For making the frozen gyoza dumplings of Examples 1 to 5 and Comparative Examples 1 to 3, a tray with a concave part was used. Specifically, 5 g each of the batter liquids of Examples 1 to 5 and Comparative Examples 1 to 3 was filled in the concave part of the tray. Then, raw gyoza dumpling (weight of one raw gyoza dumpling: 17 g) was placed in the tray such that the bottom surface (surface to be fried surface) was in contact with the batter liquid filled in the concave part, and steamed at 98° C. for 9 min, allowed to cool at 25° C. for 10 min, and rapidly frozen in a freezer (inside temperature: −30° C.) while the gyoza dumpling was adhered to the batter liquid, whereby the frozen gyoza dumplings of Examples 1 to 5 and Comparative Examples 1 to 3 were respectively obtained.

### Sensory Evaluation

Twelve frozen gyoza dumplings from each of Examples 1 to and Comparative Examples 1 to 3 were placed in a gyoza dumpling frying machine (manufactured by fujimak corporation, type “FGJ65754W”) with the bottom surface (surface to be fried surface) facing down, covered with a lid, and first fried and steamed on medium heat for 5 min. Then the lid was removed and gyoza dumplings were fried for 2 min to give gyoza dumplings with wings (winged gyoza dumplings). The spread of the wings, frying unevenness in the wings and fried surfaces, and unfried residue of the batter liquid in the gyoza dumplings with wings were confirmed by visual observation by a panel of three experts and evaluated by consensus based on the following criteria.

### Evaluation Criteria for Spread of Wings

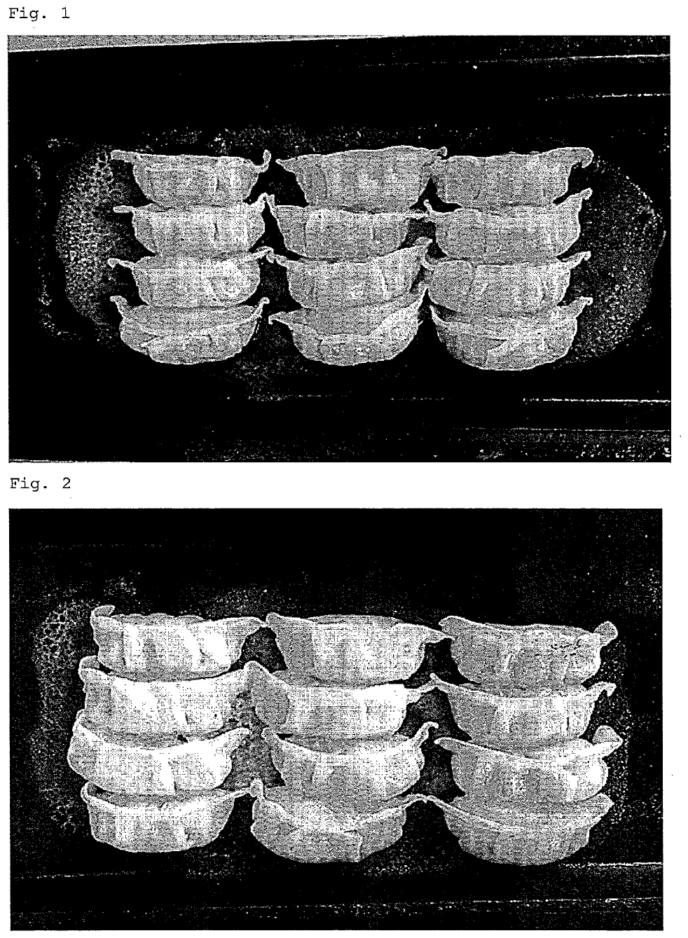

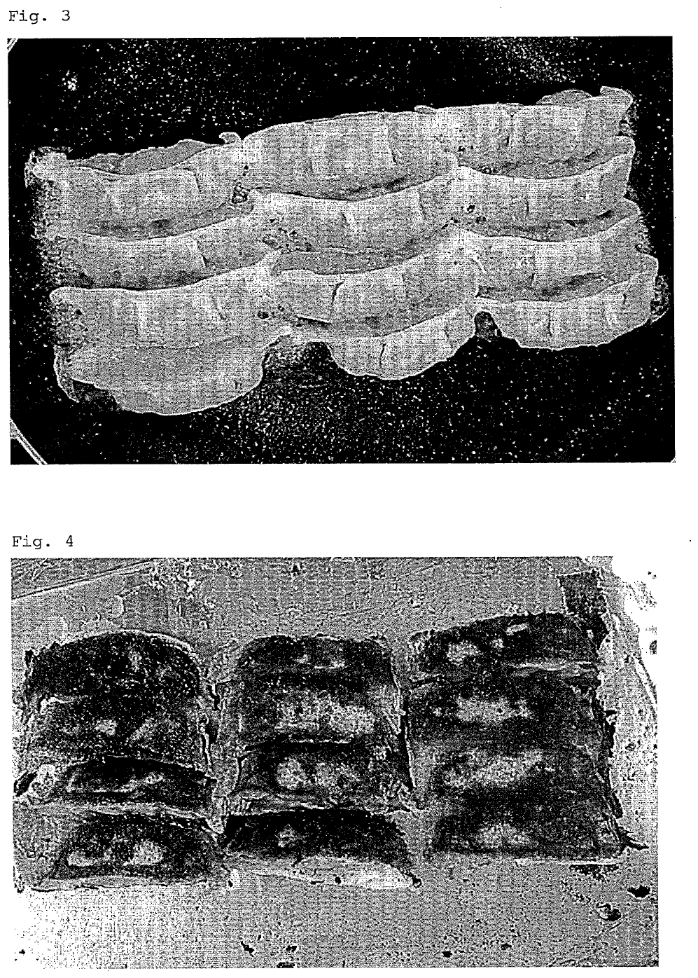

◯: wings spread widely to the outside of gyoza dumplings (typically in the state of FIG. 1)
Δ: wings spread to the outside of gyoza dumplings (typically in the state of FIG. 2)
x: wings hardly spread (typically in the state of FIG. 3).

### Evaluation Criteria for Frying Unevenness of Wings and Fried Surfaces

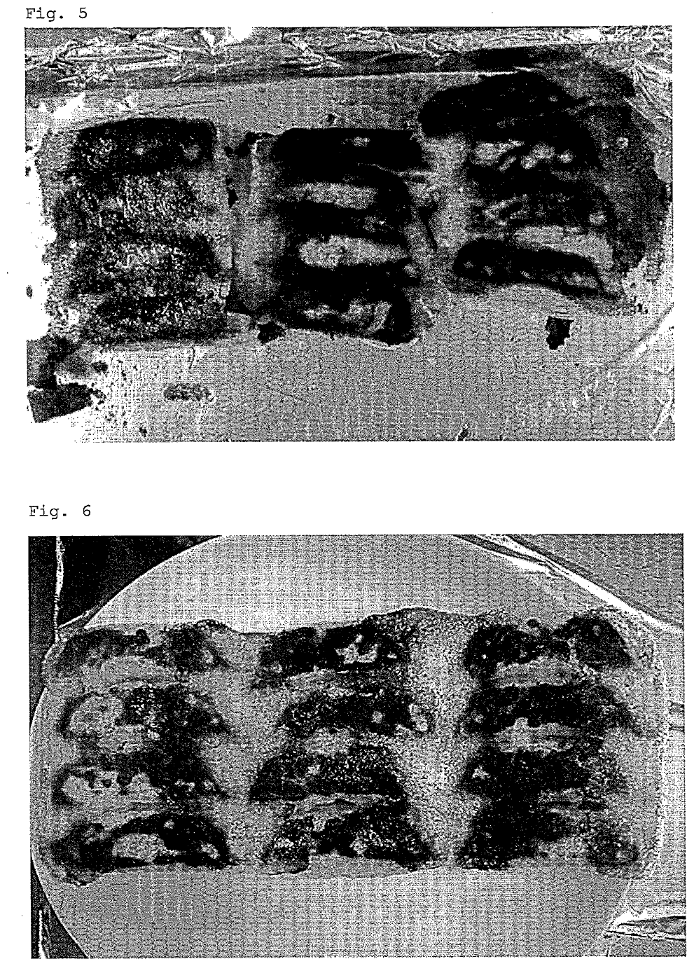

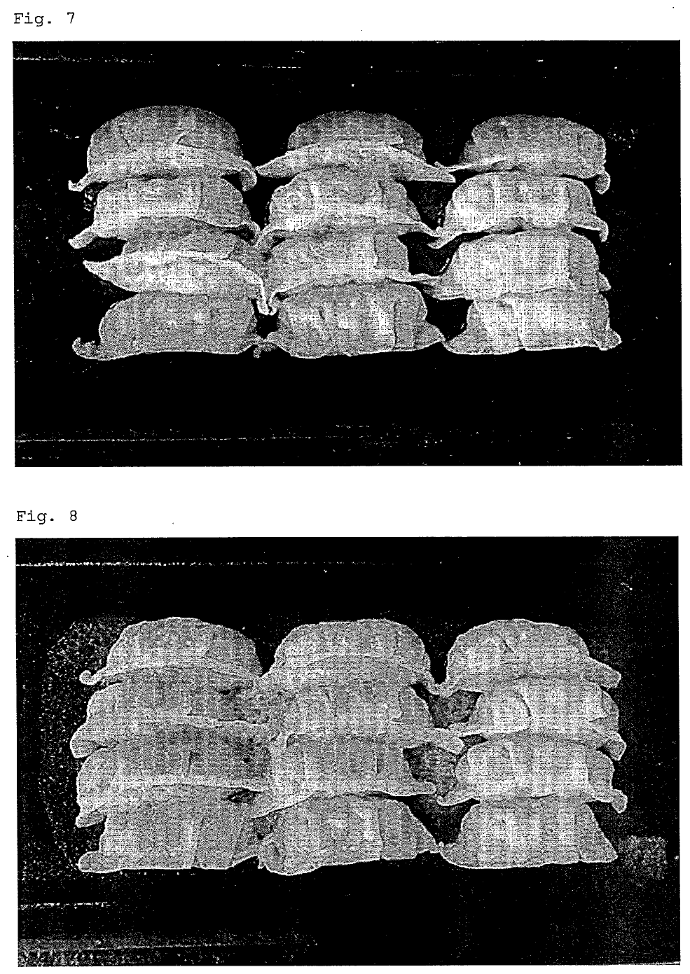

◯: the boundary between gyoza dumplings also shows fried color in addition to the wings and fried surfaces (bottom of gyoza dumplings), with less shades of colors (typically in the state of FIG. 4)
Δ: wings and fried surfaces have fried color, but fried color at the boundary between gyoza dumplings is slightly light with slight shades of colors (typically in the state of FIG. 5)
x: fried color of wings, fried surfaces, and the boundary between gyoza dumplings is light, with large shades of colors (charred bottom of gyoza dumplings, etc.) (typically in the state of FIG. 6)

### Evaluation Criteria for Unfried Residue of Batter Liquid

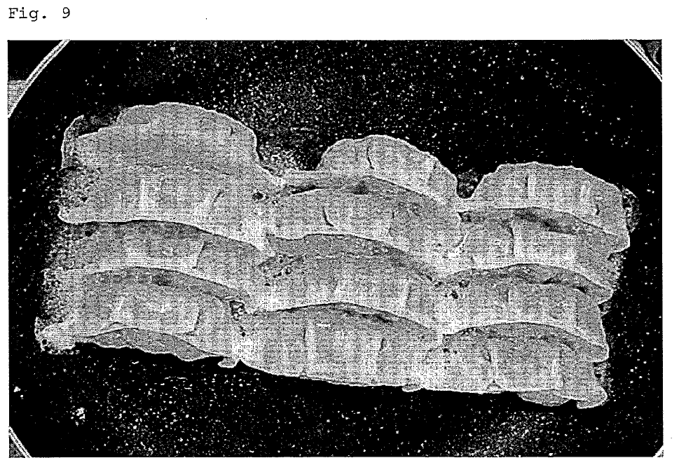

◯: almost no unfried part on the bottom of gyoza dumplings and the boundary between gyoza dumplings, and fried well (typically in the state of FIG. 7)
Δ: slightly unfried part at the boundary between gyoza dumplings, but no unfried part on the bottom of gyoza dumplings, and mostly fried (typically in the state of FIG. 8)
x: the boundary between gyoza dumplings has many unfried parts and hardly fried (typically in the state of FIG. 9)

The results are shown in the following Table 2.

TABLE 2

| | weight ratio of city water | | | | |
|---|---|---|---|---|---|
| | and alkaline electrolyzed | pH | | | |
| | water used for preparation | measurement | | | |
| | of batter liquid | value | sensory evaluation | | |
| | (city water:alkaline | (measured | spread | frying | unfried |
| sample name | electrolyzed water) | value) | of wing | unevenness | residue |
| Comparative | 100:0 | 7.3 | Δ | X | X |
| Example 1 | | | | | |
| Comparative | 99.97:0.03 | 7.5 | Δ | X | X |
| Example 2 | | | | | |
| Comparative | 99.8:0.2 | 7.6 | Δ | X | X |
| Example 3 | | | | | |
| Example 1 | 99:1 | 8.3 | ◯ | Δ | Δ |
| Example 2 | 98:2 | 9.0 | ◯ | ◯ | ◯ |
| Example 3 | 95:5 | 10.1 | ◯ | ◯ | ◯ |
| Example 4 | 90:10 | 11.3 | ◯ | ◯ | ◯ |
| Example 5 | 0:100 | 13.3 | ◯ | ◯ | ◯ |

As is clear from the results shown in Table 2, in the gyoza dumplings (gyoza dumplings with wings) obtained by heating (frying) frozen gyoza dumplings to which the batter liquids of Examples 1 to 5 having a pH of not less than 8.3 were adhered in a frozen state, the wings spread sufficiently, and frying unevenness in the wings and fried surfaces, and unfried residue of the batter liquid were sufficiently suppressed. From the results, it was confirmed that, by adjusting the agent for forming wings on gyoza dumplings to have a specific pH (e.g., not less than 8.3), the wings spread largely, and frying unevenness in the wings and fried surfaces, and unfried residue of the agent for forming wings on gyoza dumplings can be suppressed in the winged gyoza dumplings obtained by adhering the agent for forming wings on gyoza dumplings to the surface of the gyoza dumplings and heating them.

### Experimental Example 2

### Preparation of Batter Liquids of Examples 6 to 10

A batter liquid was prepared in the same manner as the batter liquid of Comparative Example 1, and respective alkali agents (calcinated shell calcium, calcium hydroxide, trisodium phosphate, polyphosphate, arginine) in the amounts shown in the following Table 3 were added to the batter liquid to respectively prepare the batter liquids of Examples 6 to 10.

### Measurement of pH of Batter Liquid

The pH of the batter liquids of Examples 6 to 10 at 25° C. was each measured in the same manner as in Experimental Example 1. The results are shown in the following Table 3.

### Making Frozen Gyoza Dumplings of Examples 6 to 10

Frozen gyoza dumplings (frozen gyoza dumplings of Examples 6 to 10) in which each batter liquid adheres in a frozen state to a surface to be the fried surface were made using the batter liquids of Examples 6 to 10 and in the same manner as in Experimental Example 1.

### Sensory Evaluation

Twelve frozen gyoza dumplings from each of Examples 6 to were placed in a gyoza dumpling frying machine (manufactured by fujimak corporation, type “FGJ65754W”) with the bottom surface (surface to be fried surface) facing down, covered with a lid, and first fried and steamed on medium heat for 5 min. Then the lid was removed and gyoza dumplings were fried for 2 min to give gyoza dumplings with wings (winged gyoza dumplings). The spread of the wings, frying unevenness in the wings and fried surfaces, and unfried residue of the batter liquid in the gyoza dumplings with wings were confirmed by visual observation by a panel of three experts and evaluated by consensus based on the same criteria as in Experimental Example 1.

The results are shown in the following Table 3.

TABLE 3

| | alkali agent | | pH | | | |
|---|---|---|---|---|---|---|
| | | amount | measurement | sensory evaluation | | |
| | | added | value | spread of | frying | unfried |
| sample name | kind | (wt %) | (measured value) | wing | unevenness | residue |
| Example 6 | calcinated shell | 0.015 | 9.9 | ◯ | ◯ | ◯ |
| | calcium | | | | | |
| Example 7 | calcium hydroxide | 0.07 | 10.5 | ◯ | ◯ | ◯ |
| Example 8 | trisodium phosphate | 0.03 | 8.6 | ◯ | ◯ | ◯ |
| Example 9 | polyphosphate | 2 | 9.1 | ◯ | ◯ | ◯ |
| Example 10 | arginine | 1 | 10.3 | ◯ | ◯ | ◯ |

As is clear from the results shown in Table 3, in the gyoza dumplings (gyoza dumplings with wings) obtained by heating (frying) frozen gyoza dumplings to which the batter liquids of Examples 6 to 10 having a specific pH adjusted using various alkali agents were adhered in a frozen state, the wings spread sufficiently, and frying unevenness in the wings and fried surfaces, and unfried residue of the batter liquid were sufficiently suppressed. From the results, it was confirmed that, by adjusting the agent for forming wings on gyoza dumplings to have a specific pH irrespective of the method for the adjustment, the wings spread largely, and frying unevenness in the wings and fried surfaces, and unfried residue of the agent for forming wings on gyoza dumplings can be suppressed in the winged gyoza dumplings obtained by adhering the agent for forming wings on gyoza dumplings to the surface of the gyoza dumplings and heating them.

### Experimental Example 3

### Preparation of Batter Liquids of Examples 11 to 14 and Comparative Example 4

A batter liquid was prepared in the same manner as the batter liquid of Comparative Example 1 in Experimental Example 1, and trisodium phosphate in the amounts shown in the following Table 4 was added to the batter liquid to respectively prepare the batter liquids of Examples 11 to 14 and Comparative Example 4.

### Measurement of pH of Batter Liquid

The pH of the batter liquids of Examples 11 to 14 and Comparative Example 4 at 25° C. was each measured in the same manner as in Experimental Example 1. The results are shown in the following Table 4.

### Making Frozen Gyoza Dumplings of Examples 11 to 14 and Comparative Example 4

Frozen gyoza dumplings (frozen gyoza dumplings of Examples 11 to 14 and Comparative Example 4) in which each batter liquid adheres in a frozen state to a surface to be the fried surface were made using the batter liquids of Examples 11 to 14 and Comparative Example 4 and in the same manner as in Experimental Example 1.

### Sensory Evaluation

Twelve frozen gyoza dumplings from each of Examples 11 to 14 and Comparative Example 4 were placed in a gyoza dumpling frying machine (manufactured by fujimak corporation, type “FGJ65754W”) with the bottom surface (surface to be fried surface) facing down, covered with a lid, and first fried and steamed on medium heat for 5 min. Then the lid was removed and gyoza dumplings were fried for 2 min to give gyoza dumplings with wings (winged gyoza dumplings). The spread of the wings, frying unevenness in the wings and fried surfaces, and unfried residue of the batter liquid in the gyoza dumplings with wings were confirmed by visual observation by a panel of three experts and evaluated by consensus based on the same criteria as in Experimental Example 1.

The results are shown in the following Table 4. In the following Table 4, the results of Example 8 in the aforementioned Experimental Example 2 are also described together with the results of Examples 11 to 14 and Comparative Example 4.

TABLE 4

| | | pH | | | |
|---|---|---|---|---|---|
| | amount of | measurement | sensory evaluation | | |
| | trisodium | value | | frying | |
| | phosphate | (measured | spread | uneven- | unfried |
| sample name | added (wt %) | value) | of wing | ness | residue |
| Comparative | 0.01 | 8.1 | Δ | X | X |
| Example 4 | | | | | |
| Example 8 | 0.03 | 8.6 | ◯ | ◯ | ◯ |
| Example 11 | 0.05 | 9.8 | ◯ | ◯ | ◯ |
| Example 12 | 0.15 | 10.5 | ◯ | ◯ | ◯ |
| Example 13 | 0.3 | 11.2 | ◯ | ◯ | ◯ |
| Example 14 | 0.5 | 11.7 | ◯ | ◯ | ◯ |

As is clear from the results shown in Table 4, in the gyoza dumplings (gyoza dumplings with wings) obtained by heating (frying) frozen gyoza dumplings to which the batter liquids of Examples 8, 11 to 14 having a specific pH adjusted using trisodium phosphate were adhered in a frozen state, the wings spread sufficiently, and frying unevenness in the wings and fried surfaces, and unfried residue of the batter liquid were sufficiently suppressed. From the results, it was confirmed that, by adjusting the agent for forming wings on gyoza dumplings to have a specific pH irrespective of the method for the adjustment, the wings spread largely, and frying unevenness in the wings and fried surfaces, and unfried residue of the agent for forming wings on gyoza dumplings can be suppressed in the winged gyoza dumplings obtained by adhering the agent for forming wings on gyoza dumplings to the surface of the gyoza dumplings and heating them.

### Experimental Example 4

### Preparation of Batter Liquid of Example 15

Of the raw materials shown in Table 5 below, a mixture of alkaline electrolyzed water and city water (mixed solution of alkaline electrolyzed water (pH=13.8) and city water (pH=7.1) at a ratio of alkaline electrolyzed water:city water=5:95 (weight ratio)), acid-treated starch (manufactured by J-OIL MILLS, INC., GELCOL R-100″), egg white powder, and casein sodium (sold by Nippon Shinyaku Co., Ltd., “casein sodium S”) were mixed in the blending ratio shown in the following Table 5, and stirred using a commercially available homogenizer (manufactured by IKA JAPAN K.K., “T50 digital ULTRA-TURRAX (registered trade mark)”) (stirring conditions: 3000 rpm, 3 min). Then, salad oil, lecithin, and xanthan gum (manufactured by DSP GOKYO FOOD & CHEMICAL Co., Ltd., “ECHO GUM”) were added in the blending ratio shown in the following Table 5, and the mixture was emulsified by stirring again using the aforementioned homogenizer (stirring conditions: 3000 rpm, 9 min) to prepare the batter liquid of Example 15.

TABLE 5

| | |
|---|---|
| mixture of alkaline | 65.0 |
| electrolyzed water | |
| and city water | |
| acid-treated starch | 10.0 |
| egg white powder | 0.2 |
| casein sodium | 0.6 |
| salad oil | 23.6 |
| lecithin | 0.4 |
| xanthan gum | 0.2 |
| total (wt %) | 100.0 |

### Preparation of Batter Liquid of Example 16

Of the raw materials shown in Table 6 below, a mixture of alkaline electrolyzed water and city water (mixed solution of alkaline electrolyzed water (pH=13.8) and city water (pH=7.1) at a ratio of alkaline electrolyzed water:city water=5:95 (weight ratio)), glutinous rice starch (manufactured by Joetsu Starch Co., Ltd., “Motyl B”), egg white powder, and casein sodium (sold by Nippon Shinyaku Co., Ltd., “casein sodium S”) were mixed in the blending ratio shown in the following Table 6, and stirred using a commercially available homogenizer (manufactured by IKA JAPAN K.K., “T50 digital ULTRA-TURRAX (registered trade mark)”) (stirring conditions: 3000 rpm, 3 min). Then, salad oil, lecithin, and xanthan gum (manufactured by DSP GOKYO FOOD & CHEMICAL Co., Ltd., “ECHO GUM”) were added in the blending ratio shown in the following Table 6, and the mixture was emulsified by stirring again using the aforementioned homogenizer (stirring conditions: 3000 rpm, 9 min) to prepare the batter liquid of Example 16.

TABLE 6

| | |
|---|---|
| mixture of alkaline | 74.0 |
| electrolyzed water | |
| and city water | |
| glutinous rice starch | 1.0 |
| egg white powder | 0.2 |
| casein sodium | 0.6 |
| salad oil | 23.6 |
| lecithin | 0.4 |
| xanthan gum | 0.2 |
| total (wt %) | 100.0 |

### Measurement of pH of Batter Liquid

The pH of the batter liquids of Examples 15 and 16 at 25° C. was each measured in the same manner as in Experimental Example 1. The results are shown in the following Table 7.

### Making Frozen Gyoza Dumplings of Examples 15 and 16

Frozen gyoza dumplings (frozen gyoza dumplings of Examples 15 and 16) in which each batter liquid adheres in a frozen state to a surface to be the fried surface were respectively made using the batter liquids of Examples 15 and 16 and in the same manner as in Experimental Example 1.

### Sensory Evaluation

Twelve frozen gyoza dumplings from each of Examples 15 and 16 were placed in a gyoza dumpling frying machine (manufactured by fujimak corporation, type “FGJ65754W”) with the bottom surface (surface to be fried surface) facing down, covered with a lid, and first fried and steamed on medium heat for 5 min. Then the lid was removed and gyoza dumplings were fried for 2 min to give gyoza dumplings with wings (winged gyoza dumplings). The spread of the wings, frying unevenness in the wings and fried surfaces, and unfried residue of the batter liquid in the gyoza dumplings with wings were confirmed by visual observation by a panel of three experts and evaluated by consensus based on the same criteria as in Experimental Example 1.

The results are shown in the following Table 7.

TABLE 7

| | pH | | | |
|---|---|---|---|---|
| | measurement | | | |
| | value | sensory evaluation | | |
| | (measured | spread of | frying | unfried |
| sample name | value) | wing | unevenness | residue |
| Example 15 | 10.2 | ◯ | ◯ | ◯ |
| Example 16 | 9.64 | ◯ | ◯ | ◯ |

As is clear from the results shown in Table 7, in each of the gyoza dumplings (gyoza dumplings with wings) obtained by heating (frying) frozen gyoza dumplings to which the batter liquids of Examples 15, 16 were adhered in a frozen state, the wings spread sufficiently, and frying unevenness in the wings and fried surfaces, and unfried residue of the batter liquid were sufficiently suppressed. From the results, it was confirmed that, by adjusting the agent for forming wings on gyoza dumplings to have a specific pH irrespective of the amount of use and the kind of starches, the wings spread largely, and frying unevenness in the wings and fried surfaces, and unfried residue of the agent for forming wings on gyoza dumplings can be suppressed in the winged gyoza dumplings obtained by adhering the agent for forming wings on gyoza dumplings to the surface of the gyoza dumplings and heating them.

### Experimental Example 5

### Preparation of Batter Liquid of Example 17

Of the raw materials shown in Table 8 below, a mixture of alkaline electrolyzed water and city water (mixed solution of alkaline electrolyzed water (pH=13.8) and city water (pH=7.1) at a ratio of alkaline electrolyzed water:city water=5:95 (weight ratio)), glutinous rice starch (manufactured by Joetsu Starch Co., Ltd., “Motyl B”), egg white powder, and casein sodium (sold by Nippon Shinyaku Co., Ltd., “casein sodium S”) were mixed in the blending ratio shown in the following Table 8, and stirred using a commercially available homogenizer (manufactured by IKA JAPAN K.K., “T50 digital ULTRA-TURRAX (registered trade mark)”) (stirring conditions: 3000 rpm, 3 min). Then, salad oil, lecithin, and xanthan gum (manufactured by DSP GOKYO FOOD & CHEMICAL Co., Ltd., “ECHO GUM”) were added in the blending ratio shown in the following Table 8, and the mixture was emulsified by stirring again using the aforementioned homogenizer (stirring conditions: 3000 rpm, 9 min) to prepare the batter liquid of Example 17.

TABLE 8

| | |
|---|---|
| mixture of alkaline | 70.0 |
| electrolyzed water | |
| and city water | |
| glutinous rice starch | 5.0 |
| egg white powder | 0.2 |
| casein sodium | 0.6 |
| salad oil | 23.6 |
| lecithin | 0.4 |
| xanthan gum | 0.2 |
| total (wt %) | 100.0 |

### Preparation of Batter Liquid of Example 18

The batter liquid of Example 18 was prepared in the same manner as the batter liquid of Example 16.

### Measurement of pH of Batter Liquid

The pH of the batter liquids of Examples 17 and 18 at 25° C. was each measured in the same manner as in Experimental Example 1. The results are shown in the following Table 9.

### Making Frozen Gyoza Dumplings of Examples 17 and 18

Using the batter liquids of Examples 17 and 18, frozen gyoza dumplings with unheated batter liquid adhered in a frozen state to the surface to be fried surface were made (frozen gyoza dumplings of Examples 17 and 18).

For making the frozen gyoza dumplings of Examples 17 and 18, a tray with a concave part was used. Specifically, 5 g each of the batter liquids of Examples 17 and 18 was filled in the concave part of the tray. Then, raw gyoza dumpling (weight of one raw gyoza dumpling: 17 g) was placed in the tray such that the bottom surface (surface to be fried surface) was in contact with the batter liquid filled in the concave part, and rapidly frozen in a freezer (inside temperature: −30° C.) while the gyoza dumpling was adhered to the batter liquid, whereby the frozen gyoza dumplings of Examples 17 and 18 were respectively obtained.

### Sensory Evaluation

Twelve frozen gyoza dumplings from each of Examples 17 and 18 were placed in a gyoza dumpling frying machine (manufactured by fujimak corporation, type “FGJ65754W”) with the bottom surface (surface to be fried surface) facing down, covered with a lid, and first fried and steamed on medium heat for 5 min. Then the lid was removed and gyoza dumplings were fried for 2 min to give gyoza dumplings with wings (winged gyoza dumplings). The spread of the wings, frying unevenness in the wings and fried surfaces, and unfried residue of the batter liquid in the gyoza dumplings with wings were confirmed by visual observation by a panel of three experts and evaluated by consensus based on the same criteria as in Experimental Example 1.

The results are shown in the following Table 9.

TABLE 9

| | pH | | | |
|---|---|---|---|---|
| | measurement | | | |
| | value | sensory evaluation | | |
| | (measured | spread | frying | unfried |
| sample name | value) | of wing | unevenness | residue |
| Example 17 | 10.1 | ◯ | ◯ | ◯ |
| Example 18 | 9.64 | ◯ | ◯ | ◯ |

As is clear from the results shown in Table 9, in each of the gyoza dumplings (gyoza dumplings with wings) obtained by heating (frying) frozen gyoza dumplings to which the batter liquids of Examples 15, 16 were adhered in a frozen state, the wings spread sufficiently, and frying unevenness in the wings and fried surfaces, and unfried residue of the batter liquid were sufficiently suppressed. From the results, it was confirmed that, by adjusting the agent for forming wings on gyoza dumplings to have a specific pH irrespective of whether or not the agent for forming wings on gyoza dumplings is heated in advance apart from the heating of frozen gyoza dumplings to a state suitable for eating, the wings spread largely, and frying unevenness in the wings and fried surfaces, and unfried residue of the agent for forming wings on gyoza dumplings can be suppressed in the winged gyoza dumplings obtained by adhering the agent for forming wings on gyoza dumplings to the surface of the gyoza dumplings and heating them.

### Experimental Example 6

### Preparation of Batter Liquid of Example 19 and Measurement of pH

The batter liquid of Example 19 was prepared in the same manner as the batter liquid of Example 17.

In addition, the pH of the batter liquid of Example 19 at 25° C. was each measured in the same manner as in Experimental Example 1. The results are shown in the following Table 10.

### Sensory Evaluation

The batter liquid (60 g) of Example 19 was poured into a frying pan to form a circle with a diameter of 25 cm, and then raw gyoza dumplings were placed on the batter liquid such that the bottom surface (surface to be the fried surface) was in contact with the batter liquid. This was repeated 12 times and a total of 12 raw gyoza dumplings were arranged in the frying pan. They were covered with a lid, and fried and steamed on medium heat for 5 min. The lid was removed and gyoza dumplings were fried for 2 min to give gyoza dumplings with wings (winged gyoza dumplings). The spread of the wings, frying unevenness in the wings and fried surfaces, and unfried residue of the batter liquid in the gyoza dumplings with wings were confirmed by visual observation by a panel of three experts and evaluated by consensus based on the same criteria as in Experimental Example 1.

The results are shown in the following Table 10.

TABLE 10

| | pH | | | |
|---|---|---|---|---|
| | measurement | | | |
| | value | sensory evaluation | | |
| | (measured | spread | frying | unfried |
| sample name | value) | of wing | unevenness | residue |
| Example 19 | 10.1 | ◯ | Δ | ◯ |

As is clear from the results shown in Table 10, in the gyoza dumplings (gyoza dumplings with wings) obtained by heating (frying) raw gyoza dumplings by using the batter liquid of Example 19, the wings spread sufficiently, and frying unevenness in the wings and fried surfaces, and unfried residue of the batter liquid were suppressed. From the results, it was confirmed that, by adjusting the agent for forming wings on gyoza dumplings to have a specific pH, the wings spread largely, and frying unevenness in the wings and fried surfaces, and unfried residue of the agent for forming wings on gyoza dumplings can be suppressed in the winged gyoza dumplings obtained by adhering, without freezing, the agent for forming wings on gyoza dumplings to the surface of the gyoza dumplings and heating them.

### INDUSTRIAL APPLICABILITY

According to the present invention, an agent for forming wings on gyoza dumplings, that can form large spreading wings, suppress frying unevenness in the wings and fried surfaces, and suppress unfried residues can be provided.

According to the present invention, moreover, a frozen gyoza dumpling that can make a winged gyoza dumpling having large spreading wing, in which frying unevenness in the wings and fried surfaces is suppressed, and unfried residue of an agent for forming wings on gyoza dumplings is suppressed, can be provided.

In addition, according to the present invention, a winged gyoza dumpling having large wings that look good, and can suppress frying unevenness in the wings and fried surfaces, and unfried residues of an agent for forming wings on gyoza dumplings, and a production method thereof can be provided.

Where a numerical limit or range is stated herein, the endpoints are included. Also, all values and subranges within a numerical limit or range are specifically included as if explicitly written out.

As used herein the words “a” and “an” and the like carry the meaning of “one or more.”

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. An agent for forming a wing on a gyoza dumpling, the agent having a pH of not less than 8.3.

2. The agent according to claim 1, wherein the pH is not less than 9.

3. The agent according to claim 1, wherein the pH is not more than 14.

4. The agent according to claim 1, comprising water and at least one selected from starches and grain flour.

5. The agent according to claim 4, further comprising an oil and an emulsifier.

6. A food set for production of a gyoza dumpling with a wing, comprising at least the agent according to claim 1 and a gyoza dumpling in combination.

7. A frozen gyoza dumpling comprising an agent for forming wings on gyoza dumplings and having a pH of not less than 8.3 adhered in a frozen state.

8. A method for producing a frozen gyoza dumpling, comprising adhering, in a frozen state, an agent for forming a wing on a gyoza dumpling and having a pH of not less than 8.3.

9. The method according to claim 8, wherein the pH is not less than 9.

10. The method according to claim 8, wherein the pH is not more than 14.

11. The method according to claim 8, wherein said agent comprises water and at least one selected from starches and grain flour.

12. The method according to claim 11, wherein said agent further comprises an oil and an emulsifier.

13. A method for producing a gyoza dumpling with a wing, comprising heating a frozen gyoza dumpling to which an agent for forming a wing on a gyoza dumpling and having a pH of not less than 8.3 is adhered in a frozen state.

14. A method for producing a gyoza dumpling with a wing, comprising adhering an agent for forming a wing on a gyoza dumpling and having a pH of not less than 8.3 to a surface and heating the gyoza dumpling.

15. The method according to claim 14, wherein the pH is not less than 9.

16. The method according to claim 14, wherein the pH is not more than 14.

17. The method according to claim 14, wherein said agent comprises water and at least one selected from starches and grain flour.

18. The method according to claim 17, wherein said agent further comprises an oil and an emulsifier.

19. A method for improving spread of a wing of a gyoza dumpling with a wing, comprising adjusting pH of an agent for forming a wing on a gyoza dumpling to not less than 8.3, and adhering the agent to a surface of the gyoza dumpling and heating the gyoza dumpling.
